(19) United States
(12) Patent Application Publication
(10) Pub. No.: US 2026/0181307 A1
(43) Pub. Date: Jun. 25, 2026

(54) EARPHONE

(71) Applicant: PANASONIC INTELLECTUAL PROPERTY MANAGEMENT CO., LTD., Osaka (JP)

(72) Inventors: Ryota TAKESHIGE, Fukuoka (JP); Arata MIYAGI, Yamaguchi (JP); Shuhei FUJITA, Fukuoka (JP)

(73) Assignee: PANASONIC INTELLECTUAL PROPERTY MANAGEMENT CO., LTD., Osaka (JP)

(21) Appl. No.: 19/389,701

(22) Filed: Nov. 14, 2025

(30) Foreign Application Priority Data
Nov. 15, 2024 (JP) 2024-199967

(51) Int. Cl. H04R 1/10

(52) U.S. Cl. CPC H04R 1/1075; H04R 1/1016; H04R 1/1083; H04R 2460/01

(57) ABSTRACT

An earphone includes an earphone main body having a housing inside which a speaker unit is incorporated; and an earpiece attached to a substantially cylindrical sound conduit provided to protrude from the housing. The sound conduit includes as mutually independent spaces, a sound emitting hole for emitting a sound emitted from the speaker unit to the earpiece, and a microphone accommodation portion in which a microphone for noise cancelling is accommodated.

### CROSS-REFERENCE TO RELATED APPLICATIONS

This application is based on and claims priority under 35 USC 119 from Japanese Patent Application No. 2024-199967 filed on Nov. 15, 2024, the contents of which are incorporated herein by reference.

### TECHNICAL FIELD

The present disclosure relates to an earphone.

### BACKGROUND ART

Patent Literature 1 discloses an earphone microphone including: a main body housing having one speaker that outputs a sound to the outside; and an ear pad that covers an insertion portion formed in the main body housing. In the earphone microphone, the main body housing includes first and second microphones for noise cancelling, and the first and second microphones and the speaker are disposed in separate spaces in the main body housing.

Patent Literature 2 discloses an earphone including: a housing portion having a speaker that outputs a sound to the outside; a protruding portion protruding toward an external space of the housing portion; and an ear chip engaged with the protruding portion. In this earphone, the housing portion includes a microphone for noise cancelling, and the microphone and the speaker are disposed in separate spaces in the housing portion.

### CITATION LIST

### Patent Literature

Patent Literature 1: JP2014-160948A

Patent Literature 2: JP2015-126509A

### SUMMARY OF INVENTION

In general, in order to improve the accuracy of noise cancelling of the earphone, it is preferable to dispose the microphone for noise cancelling at a position close to the external space (eardrum of user) of the earphone. However, in Patent Literatures 1 and 2, the microphone is disposed at a position away from the external space such that the main body housing (housing portion) includes the microphone, which is not preferable from the viewpoint of improving noise cancelling.

The present disclosure has been made in view of the above-described situation in the related art, and an object of the present disclosure is to provide an earphone having excellent accuracy of noise cancelling as compared with that in the related art.

An earphone according to the present disclosure includes an earphone main body having a housing inside which a speaker unit is incorporated; and an earpiece attached to a substantially cylindrical sound conduit provided to protrude from the housing. The sound conduit includes as mutually independent spaces, a sound emitting hole for emitting a sound emitted from the speaker unit to the earpiece, and a microphone accommodation portion in which a microphone for noise cancelling is accommodated.

According to the earphone of the present disclosure, the accuracy of noise cancelling is excellent as compared with that in the related art.

### BRIEF DESCRIPTION OF DRAWINGS

FIG. 1 is a side view of an earphone according to Embodiment 1;

FIG. 2 is a schematic cross-sectional view of the earphone illustrated in FIG. 1;

FIG. 3 is a top view of the earphone illustrated in FIG. 1 (illustration of earpiece and laminated member omitted);

FIG. 4 is an enlarged perspective view for illustrating a blocking portion of the earphone illustrated in FIG. 1;

FIG. 5 is an enlarged perspective view for illustrating a jig insertion opening of the earphone illustrated in FIG. 1;

FIG. 6 is a view for illustrating a method for assembling a microphone to a microphone accommodation portion in the earphone illustrated in FIG. 1; and

FIG. 7 is a schematic cross-sectional view illustrating an earphone according to a related art example.

### DESCRIPTION OF EMBODIMENTS

### Background of Present Disclosure

As described above, in order to improve the accuracy of noise cancelling of an earphone, it is preferable to dispose a microphone for noise cancelling at a position close to an external space (eardrum of user) of the earphone. This is because, by disposing the microphone for noise cancelling at the position close to the eardrum of the user, a sound actually reaching the eardrum of the user can be received with high accuracy. Accordingly, a difference between the received sound (sound actually reaching eardrum of user) and a sound emitted from a speaker unit can be detected with high accuracy, and therefore, the correction accuracy of noise cancelling is enhanced, and a noise can be more effectively cancelled. Therefore, some earphones in the related art include a microphone disposed in a sound emitting hole.

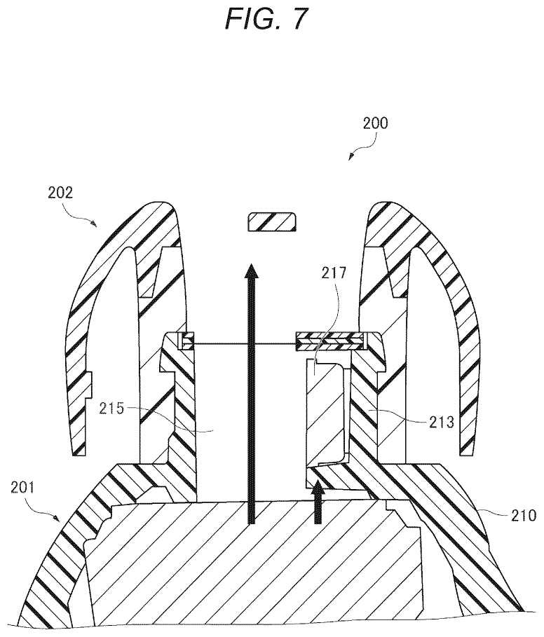

FIG. 7 is a schematic cross-sectional view illustrating an earphone 200 according to a related art example. Hereinafter, a problem of an earphone in the related art in which a microphone is disposed in a sound emitting hole will be described with reference to FIG. 7. The earphone 200 illustrated in FIG. 7 includes an earphone main body 201 having a housing 210 inside which a speaker unit (not illustrated) is accommodated, and an earpiece 202 attached to a sound conduit 213 provided to protrude from the housing 210, and a microphone 217 for noise cancelling is simply disposed in an inner space (that is, sound emitting hole 215) of the sound conduit 213.

In the earphone 200 illustrated in FIG. 7, since the microphone 217 is disposed in the sound emitting hole 215, the accuracy of noise cancelling is excellent as compared to that of Patent Literatures 1 and 2. On the other hand, since the microphone 217 is disposed in the sound emitting hole 215, resistance of the microphone 217 is generated in the sound emitting hole 215. This resistance has an influence particularly on a high range, and clarity of a sound may be impaired. In addition, due to the microphone 217 disposed in the sound emitting hole 215, the sound emitted from the speaker unit may hit the microphone 217 and be reflected, or a phase of a sound propagating through the sound emitting hole 215 may be disturbed. In this case, resolution of the sound is reduced or a balance of the sound quality is lost. As described above, in earphones in the related art including those disclosed in Patent Literatures 1 and 2 and the earphone 200 illustrated in FIG. 7, the noise cancelling and the sound quality are in a trade-off relation.

Hereinafter, embodiments of the present disclosure will be described in detail with reference to the drawings as appropriate. However, an unnecessarily detailed description may be omitted. For example, a detailed description of well-known matters and the redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matters described in the claims.

### Embodiment 1

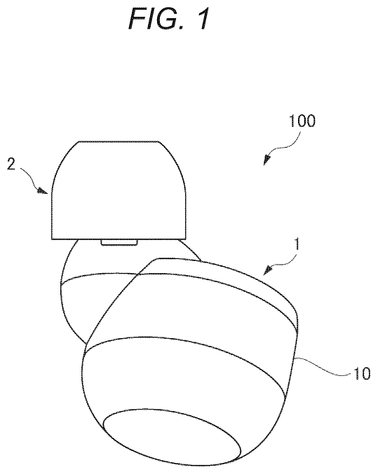

FIG. 1 is a side view of an earphone 100 according to Embodiment 1. The earphone 100 includes an earphone main body 1 and an earpiece 2.

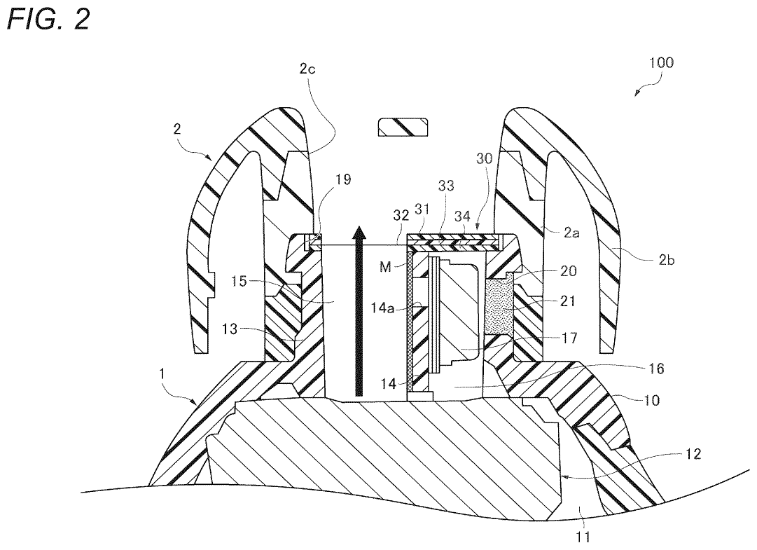

FIG. 2 is a schematic cross-sectional view of the earphone illustrated in FIG. 1. As illustrated in FIG. 2, the earphone main body 1 includes a housing 10 and a speaker unit 12. An inside of the housing 10 is an accommodation space 11, and the speaker unit 12 and the like (for example, control board and rechargeable battery) are accommodated in the accommodation space 11. The housing 10 is provided with a substantially cylindrical sound conduit 13 protruding therefrom, and the earpiece 2 is attached to the sound conduit 13.

In the present description, unless otherwise specified, an upper side is a side (corresponding to upper side of paper surface in FIG. 2) on which a sound passing through the sound conduit 13 is emitted from the sound emitting hole 15, and a lower side is a side (corresponding to lower side of paper surface in FIG. 2) on which the speaker unit 12 is accommodated.

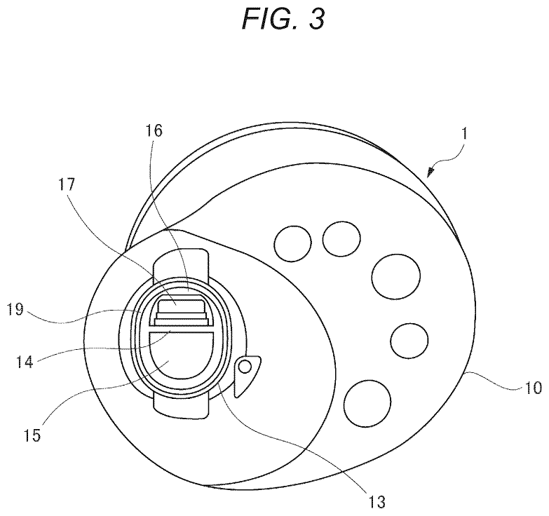

FIG. 3 is a top view of the earphone illustrated in FIG. 1 (illustration of earpiece and laminated member omitted). As illustrated in FIGS. 2 and 3, the sound conduit 13 is provided with a partition wall 14 in an inner space thereof, and the sound emitting hole 15 and a microphone accommodation portion 16 are partitioned by the partition wall 14. In other words, in the inner space of the sound conduit 13, the sound emitting hole 15 and the microphone accommodation portion 16 are provided side by side in a radial direction of the sound conduit 13 as mutually independent spaces.

The sound emitting hole 15 is a space that communicates with the accommodation space 11 and emits a sound (vibration) emitted from the speaker unit 12 to the earpiece 2. Accordingly, the speaker unit 12 is set to emit the sound toward the sound emitting hole 15.

The microphone accommodation portion 16 is a space for accommodating a microphone 17 for noise cancelling. In the microphone accommodation portion 16, the microphone 17 is accommodated so as to be assembled to the partition wall 14.

The microphone 17 is a well-known feedback microphone having a function of receiving the sound emitted from the speaker unit 12 and propagating through the sound emitting hole 15. Therefore, the partition wall 14 is provided with a wall hole 14a through which the sound emitting hole 15 and the microphone accommodation portion 16 communicate with each other such that the microphone 17 can receive the sound emitted from the speaker unit 12 and propagating through the sound emitting hole 15.

A mesh material M is provided on a surface of the partition wall 14 on a sound emitting hole 15 side so as to block the wall hole 14a. The mesh material M has the same function as an acoustic mesh 32 (refer to the following description), that is, a function of dampening (controlling) vibration of a sound transmitted from the sound emitting hole 15. Accordingly, by dampening (controlling) the vibration of the sound transmitted from the sound emitting hole 15 by the mesh material M, howling and the like can be prevented, and stable noise cancelling can be achieved.

As a noise cancelling method of the earphone 100 using the microphone 17, a known method can be adopted. Hereinafter, an example of the noise cancelling function will be described. First, the microphone 17 receives the sound from the sound emitting hole 15 and transmits a sound reception signal to a control board (not illustrated). Subsequently, the control board analyzes the received sound reception signal in real time to generate a correction signal for the noise cancelling, and transmits the correction signal to the speaker unit 12. Subsequently, the speaker unit 12 reproduces the received correction signal together with an audio signal to be reproduced or being reproduced. Thus, the noise cancelling of the earphone is realized.

The earphone main body 1 may further include a microphone for noise cancelling (that is, feedforward microphone) on the outside of the housing 10. In this case, by combining the microphone 17 (feedback microphone) and the feedforward microphone, noise cancelling with higher accuracy can be realized.

A locking claw 18 for retaining the earpiece 2 is provided at a distal end (upper end) of the sound conduit 13, and the locking claw 18 is formed so as to expand in a diameter enlarging direction with respect to an outer peripheral surface of the sound conduit 13. That is, the locking claw 18 is formed in a flange shape.

The distal end of the sound conduit 13 is provided with an annular recess 19 formed by enlarging an inner diameter of the sound conduit 13. The annular recess 19 is an annular recess in which an inner peripheral surface of the distal end of the sound conduit 13 is recessed in the diameter enlarging direction over the entire region in a circumferential direction. A laminated member 30 (refer to the following description) is provided in the annular recess 19.

The laminated member 30 includes a dustproof sheet 31, an acoustic mesh 32, and double-sided tapes 33 and 34. The dustproof sheet 31 is a sheet-like member for preventing a foreign matter from intruding into an inside of the housing 10. The acoustic mesh 32 is a mesh-like or porous plate-like member for dampening (controlling) vibration of the sound transmitted from the sound emitting hole 15. The double-sided tape 33 is a tape-like member for attaching the dustproof sheet 31 and the acoustic mesh 32. The double-sided tape 34 is a tape-like member for attaching the laminated member 30 to the annular recess 19.

That is, the laminated member 30 includes the dustproof sheet 31, the double-sided tape 33, the acoustic mesh 32, and the double-sided tape 34 laminated in this order from the upper side, and is attached to the annular recess 19 via the double-sided tape 34.

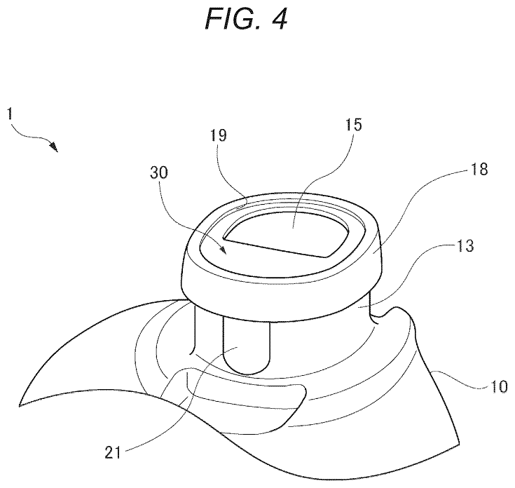

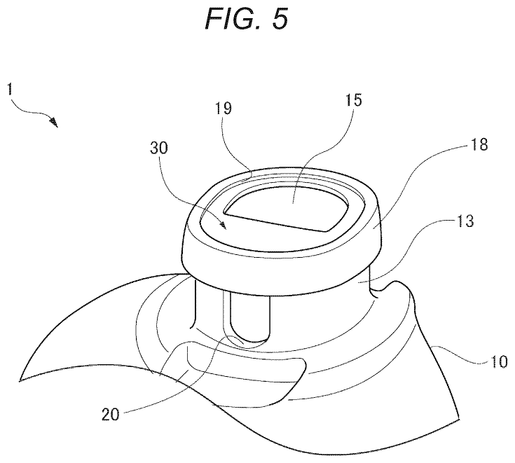

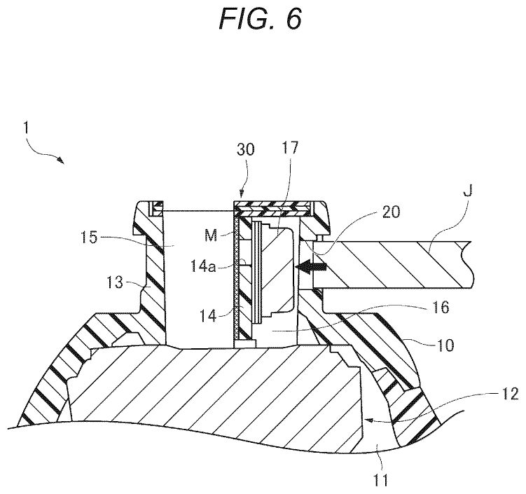

FIG. 4 is an enlarged perspective view for illustrating a blocking portion of the earphone illustrated in FIG. 1. FIG. 5 is an enlarged perspective view for illustrating a jig insertion opening of the earphone illustrated in FIG. 1. FIG. 6 is a view for illustrating a method for assembling a microphone to a microphone accommodation portion in the earphone illustrated in FIG. 1.

As illustrated in FIGS. 2 and 4, the sound conduit 13 includes, on a peripheral wall thereof, a blocking portion 21 that blocks a jig insertion opening 20 (see also FIG. 5) into which a dedicated jig J for assembling the microphone 17 to the microphone accommodation portion 16 can be inserted.

For example, as illustrated in FIG. 6, the microphone 17 disposed in the microphone accommodation portion 16 is assembled to the partition wall 14 by the jig J inserted into the microphone accommodation portion 16 through the jig insertion opening 20. After the assembly of the microphone 17 to the partition wall 14 is completed, the microphone 17 receives a sound from the outside of the housing 10 in a state where the jig insertion opening 20 is opened, and a function thereof is impaired. Therefore, after the above-described assembly is completed, the blocking portion 21 is formed by blocking the jig insertion opening 20 with a predetermined material such as an adhesive. Accordingly, the function of the microphone 17 is ensured.

As illustrated in FIG. 2, the earpiece 2 integrally includes a base portion 2a and an umbrella portion 2b.

The base portion 2a is formed in a substantially cylindrical shape, and is provided with a through hole 2c penetrating through the base portion 2a over the entire region in the axial direction (up-down direction in drawing). By inserting the sound conduit 13 of the earphone main body 1 into the through hole 2c, the earpiece 2 is attached to the sound conduit 13. Accordingly, the through hole 2c communicates with the sound emitting hole 15, and thus the sound (vibration) emitted from the speaker unit 12 is emitted to the through hole 2c (earpiece 2) through the sound emitting hole 15.

An inner diameter of the base portion 2a is equal to or smaller than an outer diameter of the sound conduit 13. Accordingly, in a state in which the earpiece 2 is attached to the sound conduit 13, an inner peripheral surface of the base portion 2a and the outer peripheral surface of the sound conduit 13 strongly adhere to each other.

The umbrella portion 2b is connected to an upper end of the base portion 2a over the entire periphery thereof, and extends toward a lower end side of the base portion 2a so as to cover an outer periphery of the base portion 2a. Accordingly, substantially the entire outer peripheral surface of the base portion 2a is covered with the umbrella portion 2b. The umbrella portion 2b has a function of coming into contact with an ear canal of the user and sealing the ear canal in a state in which the user wears the earphone 100.

As the earpiece 2, a known earpiece having a configuration different from the above-described configuration may be used, and the configuration is not particularly limited.

As described above, in the earphone 100, in order to allow the microphone 17 to be disposed in the microphone accommodation portion 16 included in the sound conduit 13, the microphone 17 is positioned closer to the eardrum of the user than in the related art, resulting in excellent accuracy of noise cancelling. In addition, in the earphone 100, the sound emitting hole 15 and the microphone accommodation portion 16 are formed as mutually independent spaces, and thus it is possible to achieve both high-accuracy noise cancelling and high-accuracy sound quality.

Further, in the earphone 100, the sound emitting hole 15 and the microphone accommodation portion 16 can be formed as mutually independent spaces with a simple structure such that an internal space of the sound conduit 13 is partitioned into the sound emitting hole 15 and the microphone accommodation portion 16 by the partition wall 14.

Further, in the earphone 100, since the partition wall 14 is provided with the wall hole 14a, although the sound emitting hole 15 and the microphone accommodation portion 16 are formed as mutually independent spaces, the sound propagating through the sound emitting hole 15 can be received by the microphone 17 with high accuracy.

### Summary of Embodiment 1

The following techniques are disclosed based on the above description of Embodiment 1.

### Technique 1

An earphone (100) including:
an earphone main body (1) having a housing (10) inside which a speaker unit (12) is incorporated; and
an earpiece (2) attached to a substantially cylindrical sound conduit (13) provided to protrude from the housing (10), in which
the sound conduit (13) includes,
as mutually independent spaces, a sound emitting hole (15) for emitting a sound emitted from the speaker unit (12) to the earpiece (2), and a microphone accommodation portion (16) in which a microphone (17) for noise cancelling is accommodated.

According to this configuration, since the microphone for noise cancelling is disposed in the microphone accommodation portion of the sound conduit, the microphone is positioned closer to the eardrum of the user than in the related art, resulting in excellent accuracy of noise cancelling. In addition, according to the present configuration, since the microphone accommodation portion and the sound emitting hole for emitting the sound emitted from the speaker unit to the earpiece are formed as mutually independent spaces, it is possible to achieve both high-accuracy noise cancelling and high-accuracy sound quality.

### Technique 2

The earphone (100) according to technique 1, in which
the sound conduit (13) has a partition wall (14) that partitions an inner space into the sound emitting hole (15) and the microphone accommodation portion (16).

According to this configuration, the sound emitting hole and the microphone accommodation portion can be formed as mutually independent spaces with a simple structure such that the inner space of the sound conduit is partitioned into the sound emitting hole and the microphone accommodation portion by the partition wall.

### Technique 3

The earphone (100) according to technique 2, in which
the partition wall (14) is provided with a wall hole (14a) through which the sound emitting hole (15) and the microphone accommodation portion (16) communicate with each other such that the microphone (17) can receive a sound emitted from the speaker unit (12) and propagating through the sound emitting hole (15).

According to this configuration, since the partition wall is provided with the wall hole, although the sound emitting hole and the microphone accommodation portion can be formed as mutually independent spaces, the sound propagating through the sound emitting hole can be received by the microphone with high accuracy.

### Technique 4

The earphone (100) according to any of techniques 1 to 3, in which
the sound conduit (13) is provided with a jig insertion opening (20) into which a jig (J) for assembling the microphone (17) into the microphone accommodation portion (16) is inserted, and
the sound conduit (13) has a blocking portion (21) that blocks the jig insertion opening (20).

According to this configuration, even when the sound emitting hole and the microphone accommodation portion are formed as mutually independent spaces, the microphone can be easily assembled to the microphone accommodation portion from the outside of the sound conduit through the jig insertion opening. In addition, after the assembly of the microphone to the microphone accommodation portion is completed, the jig insertion opening is blocked by the blocking portion, thereby ensuring the function of the microphone.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely within a range without departing from the gist of the invention.

### INDUSTRIAL APPLICABILITY

The techniques of the present disclosure are useful for an earphone having a microphone for noise cancelling (feedback microphone).

What is claimed is:

1. An earphone comprising:
an earphone main body having a housing inside which a speaker unit is incorporated; and
an earpiece attached to a substantially cylindrical sound conduit provided to protrude from the housing, wherein
the sound conduit includes,
as mutually independent spaces, a sound emitting hole for emitting a sound emitted from the speaker unit to the earpiece, and
a microphone accommodation portion in which a microphone for noise cancelling is accommodated.

2. The earphone according to claim 1, wherein
the sound conduit has a partition wall that partitions an inner space into the sound emitting hole and the microphone accommodation portion.

3. The earphone according to claim 2, wherein
the partition wall is provided with a wall hole through which the sound emitting hole and the microphone accommodation portion communicate with each other such that the microphone can receive a sound emitted from the speaker unit and propagating through the sound emitting hole.

4. The earphone according to claim 1, wherein
the sound conduit is provided with a jig insertion opening into which a jig for assembling the microphone into the microphone accommodation portion is inserted, and
the sound conduit has a blocking portion that blocks the jig insertion opening.
